(19) United States
(12) Patent Application Publication
(10) Pub. No.: US 2011/0220762 A1
(43) Pub. Date: Sep. 15, 2011

(54) ACTUATION SYSTEM FOR A LIFT ASSISTING DEVICE AND ROLLER BEARINGS USED THEREIN

(75) Inventors: Frederick S. Gyuricsko, Torrington, CT (US); Maura Simpson, Fairfield, CT (US)

(73) Assignee: ROLLER BEARING COMPANY OF AMERICA, INC., Oxford, CT (US)

(21) Appl. No.: 13/053,945

(22) Filed: Mar. 22, 2011

Related U.S. Application Data
(63) Continuation-in-part of application No. 12/201,062, filed on Aug. 29, 2008.
(60) Provisional application No. 60/992,746, filed on Dec. 6, 2007.

(51) Int. Cl. B64C 9/14; B64C 13/00; B64C 13/28; B64C 13/34

(52) U.S. Cl. 244/99.3

(57) ABSTRACT

An aircraft wing includes a wing structure, a slat panel mounted on a track, and an actuator mechanism on the wing structure coupled to the track for moving the slat panel between a deployed position and a retracted position. Track roller bearings on the wing structure rotatably contact the track, and side roller bearings on the wing structure rotatably contact at least one side of the track. In another configuration, the actuator mechanism includes a shaft rotatably mounted on the wing structure, an actuator arm coupled to the track by a bearing linkage, and an actuator lever coupled to the shaft by a bearing linkage and to the actuator arm by a bearing linkage. At least one bearing linkage includes a spherical plain bearing.

### CROSS-REFERENCE TO RELATED APPLICATIONS

This application is a continuation-in-part of U.S. application Ser. No. 12/201,062, entitled “Actuation System for a Lift Assisting Device and Roller Bearings Used Therein,” filed Aug. 29, 2008, now pending, which claims benefit under 35 U.S.C. §119(e) of U.S. Provisional Patent Application Ser. No. 60/992,746, entitled “Lined Track Roller,” filed Dec. 6, 2007, the disclosures of which are incorporated by reference herein in their entireties.

### FIELD OF THE INVENTION

This invention relates to roller bearing assemblies and bearing linkages for use in aircraft applications and, more particularly, to roller bearing assemblies and bearing linkages used within an actuation system of an aircraft assembly.

### DESCRIPTION OF THE RELATED ART

The wings of fixed wing aircraft typically include slats movably arranged along a leading edge of each wing and flaps movably arranged along a trailing edge of each wing. By selectively extending, retracting, and deflecting the slats and flaps, aerodynamic flow conditions on a wing are influenced to increase lift generated by the wing during takeoff or decrease lift during landing. During take-off, for example, the leading edge slats are moved forward to extend an effective chord length of the wing and improve lift. During cruise portions of flight, the leading edge slats and trailing edge flaps are placed in a retracted position to optimize aerodynamic conditions.

The leading edge slats are fixedly mounted on tracks, and aircraft wings carry an actuation mechanism to extend the leading edge slats to increase lift at slow speeds for landing and takeoff, and then retract the leading edge slats again during cruise. The wings also include a series of roller style bearings that engage and guide the tracks as the leading edge slats are extended and retracted. The tracks may have multiple configurations such as, for example, general I-beam and Pi-beam shapes. Track roller bearings and side load rollers or pins are employed to center and support the track under load conditions. The wing also includes actuation systems for positioning the slats and flaps.

### SUMMARY OF THE INVENTION

The present invention resides in one aspect in an aircraft wing which comprises a wing structure, a slat panel mounted on a track, and an actuator mechanism on the wing structure coupled to the track for moving the slat panel between a deployed position and a retracted position. A plurality of track roller bearings is mounted on the wing structure, rotatably contacting the track, and a plurality of side roller bearings is mounted on the wing structure rotatably contacting at least one side of the track.

The present invention resides in another aspect in an aircraft wing comprising a wing structure, a slat panel mounted on a track, and an actuator mechanism on the wing structure and coupled to the track for moving the slat panel between a deployed position and a retracted position. The actuator mechanism includes a shaft rotatably mounted on the wing structure, an actuator arm coupled to the track by a bearing linkage, and an actuator lever coupled to the shaft by a bearing linkage and to the actuator arm by a bearing linkage. There are a plurality of track roller bearings on the wing structure, the track roller bearings rotatably contacting the track, and a plurality of side roller bearings rotatably contacting at least one side of the track. At least one bearing linkage comprises a spherical plain bearing.

The present invention resides in another aspect in an actuation system for deploying and retracting a lift assisting device of a wing of an aircraft. The actuation system comprises a track pivotally coupled to a lift assisting device, an actuator coupled to the track, and a plurality of track roller bearings rotatably contacting the track to guide the track along an arcuate path. The track roller bearing comprises an outer ring having inner bearing surfaces, an inner ring having outer bearing surfaces, a shield disposed about shoulder portions of an outer diameter of the outer ring and extending to an outer diameter of the inner ring, and a seal located under the shield and retained against an outward facing surface of the inner ring.

### BRIEF DESCRIPTION OF THE DRAWINGS

FIG. 1 is a plan view of a wing of an aircraft illustrating a plurality of slat panels located at a leading edge section of the wing.

FIG. 2A is a side cross-sectional view of the wing of FIG. 1 taken along line 2-2 illustrating one of the slat panels in a deployed and a retracted position.

FIG. 2B is a schematic cross-sectional view of the track and track roller bearings of FIG. 2A.

FIG. 2C is a schematic cross-sectional view of a track with a track roller bearing and side pad.

FIG. 2D is a schematic cross-sectional view of a bearing linkage in FIG. 2A according to one embodiment.

FIG. 2E is a schematic cross-sectional view of a bearing linkage in FIG. 2A according to another embodiment.

FIG. 3 is a front, partial cross-sectional view of a portion of the wing illustrating an actuation system for a slat panel, in accordance with one embodiment of the present invention.

FIG. 4 is a cross-sectional view of a track roller bearing in accordance with one embodiment of the present invention.

FIG. 5A is a partial cross-sectional front view of a portion of a wing illustrating side guide roller bearings in accordance with one embodiment of the present invention.

FIG. 5B is a partial cross-sectional view of a side guide roller bearing.

FIG. 6 is a side cross-sectional view of a track roller bearing having outer and inner hard surfaces.

### DETAILED DESCRIPTION OF THE INVENTION

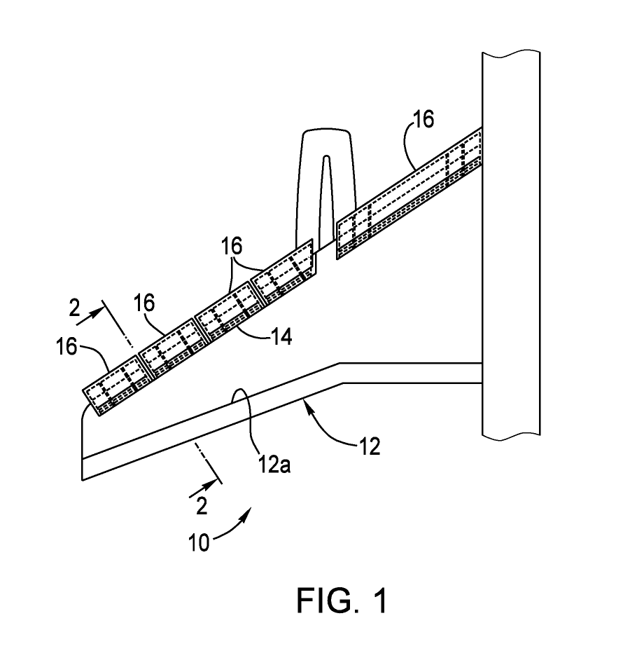

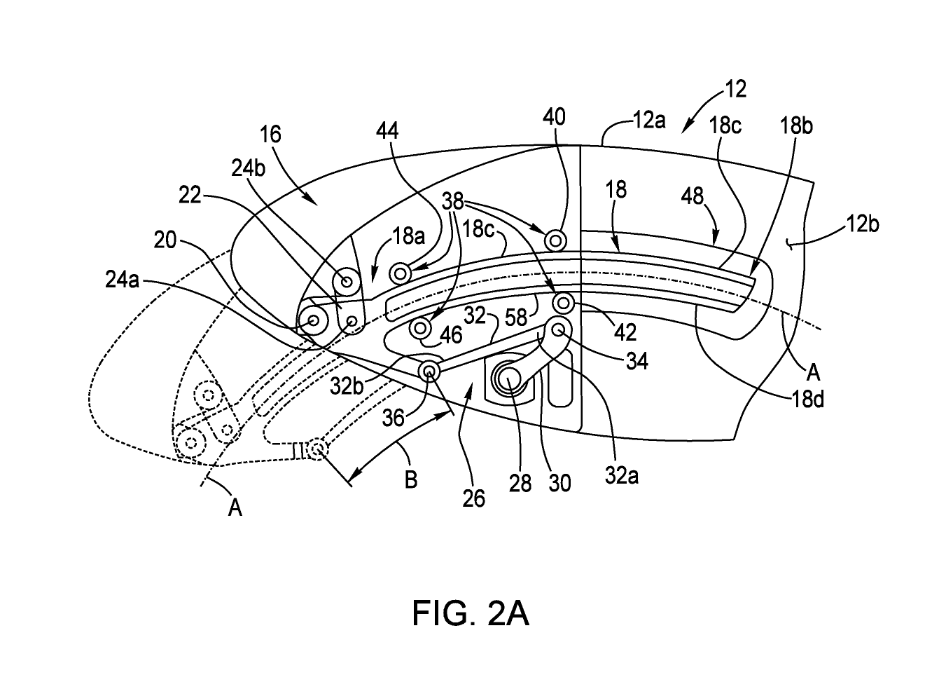

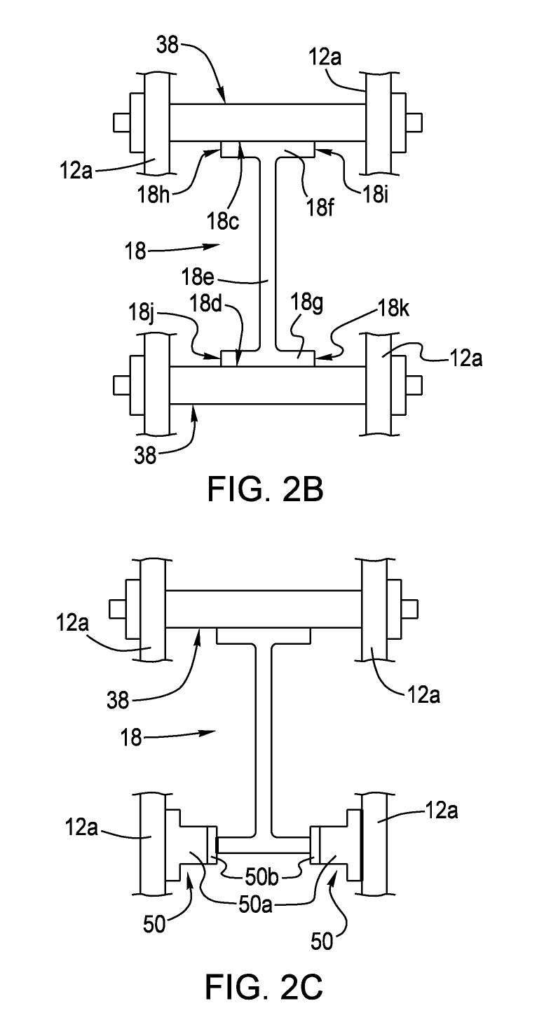

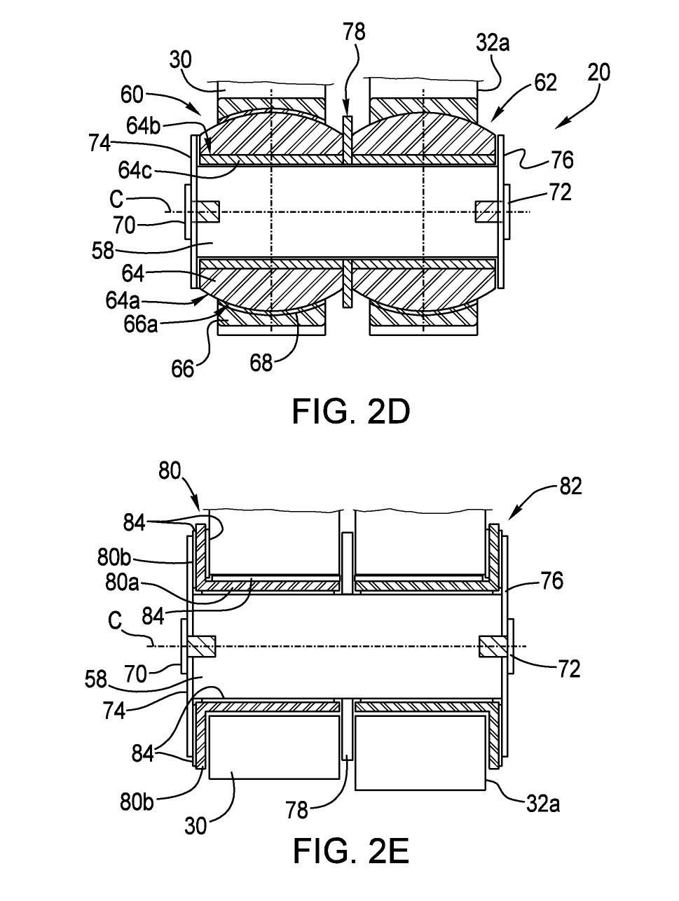

An aircraft indicated generally at 10 in FIG. 1 has at least two wings, one of which is indicated at 12. The wing 12 includes a wing structure 12a which has leading edge section 14 along which a plurality of slat panels 16 are situated. As indicated in FIG. 2A, each slat panel 16 is mounted on at least one track 18 which extends along an arcuate axis “A” from a front portion 18a to a rear portion 18b. The track 18 may be made from titanium or steel, and in some embodiments, the track may include an optional coating of tungsten carbide or the like. The present invention is not limited to the inclusion of a coating on the track, however, as the track may be employed without a coating. The front portion 18a is coupled to an interior surface of the slat panel 16. In one embodiment, the track 18 is coupled to the slat panel 16 by a bearing linkage 20 and by a coupling link 22. The coupling link 22 has two ends and is coupled at one end directly to the track 18 by a bearing linkage 24a and at the other end directly to the slat panel 16 by a bearing linkage 24b. The invention is not limited in this regard, and in other embodiments, the slat panel 16 may be coupled to the track 18 using other suitable configurations.

An actuation system 26 engages the track 18 to selectively move the slat panels 16 relative to the leading edge section 14 as indicated by arrow B in response to flight control signals, i.e., the slat panels 16 move between a retracted position (indicated in solid line) and an extended or deployed position (indicated by dashed lines). In the retracted position (e.g., cruise position) the slat panel 16 is located against the leading edge section 14 of the wing structure 12a, and in the extended position (e.g., take-off and landing position) the slat panel 16 is deployed downwardly and forwardly away from the leading edge section 14 of the wing structure 12a thus effectively increasing a surface area of the wing 12 to vary the lift-enhancing characteristics of the wing. During deployment and retraction, the track 18 moves in an arcuate path along the arcuate axis A.

In one embodiment, the actuation system 26 on the aircraft 10 includes a shaft 28 rotatably mounted on the wing structure 12a. An actuator lever 30 is mounted on the shaft 28, and the actuator lever 30 is coupled to the track 18 via an actuator arm 32 having a first end 32a and a second end 32b. The first end 32a is pivotally coupled to the actuator lever 30 at a bearing linkage 34, and the second end 32b is pivotally coupled to the front portion 18a of the track 18 at a bearing linkage 36. The shaft 28 extends along the leading edge section 14 of the wing structure 12a and operates a plurality of actuator levers (similar to lever 30) coupled to the plurality of slat panels 16. The shaft 28 rotates in response to flight control commands, rotating in a first direction to extend the slat panels 16 and rotating in a second direction to retract the slat panels.

A plurality of track roller bearings 38 is mounted on the wing structure 12a such that the track roller bearings are disposed about a top surface 18c and a bottom surface 18d of the track 18. The track roller bearings 38 are in rotational contact with the top and bottom surfaces 18c, 18d of the track 18 to guide the track in a path along arcuate axis A during deployment and retraction. In one embodiment, the plurality of track roller bearings 38 includes a first pair of roller bearings 40 and 42 and a second pair of roller bearings 44 and 46, which are positioned to provide rolling support to the track 18 by bearing against the top and bottom surfaces 18c, 18d. It should be appreciated that it is within the scope of the present invention to include more or less than the illustrated two pairs of track roller bearings. For example, three roller bearings may be disposed about one or both of the top surface 18c and bottom surface 18d of the track 18. Multiple load conditions are experienced at the track during operation that may be carried and distributed to the wing structure 12a of the aircraft 10 by the track roller bearings 38. The track roller bearings 38 may comprise needle style rollers and/or self lubricating rollers. In one embodiment, a mounting web 48 in the wing structure 12a encloses at least a portion of the track 18. In some aircraft 10, the mounting web 48 extends into a fuel tank 12b disposed within the wing structure 12a.

In one embodiment indicated in FIG. 2B, the track 18 has, in cross-section, an I-beam configuration having a central web portion 18e and two flange elements 18f, 18g which provide the top and bottom surfaces 18c, 18d. A track roller bearing 38 may be positioned for contact with the top and bottom surfaces 18c, 18d to support and guide the track 18. The flange elements 18f and 18g define side surfaces 18h, 18i, 18j, and 18k. In another embodiment, one or more side surfaces 18h, 18i, 18j, and 18k may be guided by contact with side rubbing pads mounted on the wing structure 12a. For example, as seen in FIG. 2C, side surfaces 18j, 18k are contacted by side rubbing pads 50. In one embodiment, a side rubbing pad 50 comprises a pad substrate 50a and a liner 50b on the pad substrate. The pad substrate 50a may be made from aluminum, titanium, steel, or a composite material such as fiberglass epoxy, carbon fiber epoxy, or the like. The liner 50b may be self-lubricating.

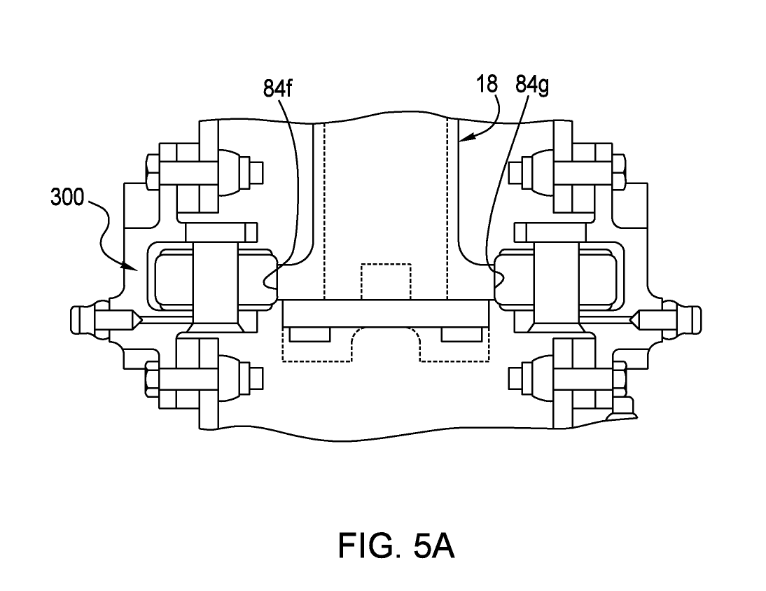

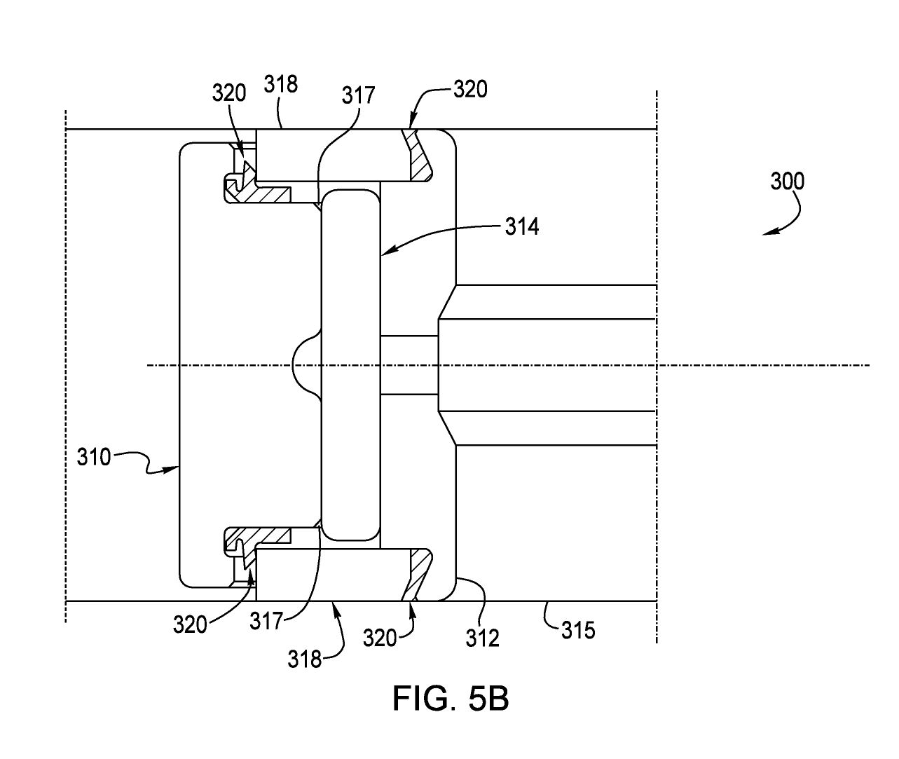

In another embodiment, any of side surfaces 18h, 18i, 18j, and 18k may be supported and/or guided by side rollers of the type described with reference to FIGS. 5A and 5B.

In various embodiments, each bearing linkage (designated as 34, 36, 20, 24a, or 24b) may comprise one or more spherical plain bearings and/or one or more bushings. In one embodiment shown in FIG. 2D, the bearing linkage 20 comprises a linking pin 58 which is mounted in the actuator lever 30 and in the first end 32a of the actuator arm 32 by spherical plain bearings 60 and 62, which may be configured similarly to each other. The spherical plain bearing 60 comprises an inner ring member 64 and an outer ring member 66. The outer ring member 66 has an annular configuration with a central axis C and a spherical concave bearing surface 66a that faces the central axis. The inner ring member 64 has a spherical convex bearing surface 64a. As shown, a liner 68 is disposed between surface 66a and surface 64a, being secured to surface 64a and positioned for sliding contact with surface 66a. However, the invention is not limited in this regard, as the liner 68 may be secured to surface 66a for sliding contact with surface 64a. In the alternative, the inner ring member 64 and the outer ring member 66 can be used without the liner 68 present. However, as shown the inner ring member 64 includes an interior bore defined by an interior surface 64b, in which the linking pin 58 is rotatably received, and the spherical plain bearing 60 includes a liner 64c secured onto the interior surface 64b, leaving a surface of the liner exposed to the interior bore for sliding contact with the linking pin 58. The linking pin 58 is held in place in the spherical plain bearings 60, 62 by screws 70, 72 and washers 74, 76. The spherical plain bearings 60, 62 are separated by a self-lubricating spacer 78.

The inner ring member 64 and outer ring member 66 may be made from various materials. For example, the outer ring member 66 may be fabricated from titanium or steels such as 17-4PH®, 15-5PH®, PH13-8Mo®, AISI Type 300 or 400 series stainless material, or the like, and the inner ring member 66 may be made from titanium or stainless steels such as AISI Type 440C, AISI Type 52100, Custom 455®, Custom 465® (CUSTOM 455 and CUSTOM 465 are registered trademarks of CRS Holdings, Inc., Wilmington, Del., USA), AISI Type 422 stainless surface-treated with a nitriding process such as, for example, the AeroCres® process (AEROCRES is registered trademark of RBC Aircraft Products, Inc., Oxford, Conn. USA), XD-15NW steel (a trademark of Aubert & Duval, Tour Maine Montparnasse 33, avenue du Maine F-75015 Paris, France), Cronidur 30® (available from FAG OEM and Handel AG of Germany), or corrosion resistant steel such as 17-4PH, 15-5PH, PH13-8Mo, or the like. Optionally, the inner ring member 64 may be surface-treated for increased hardness. The inner ring member 64 may optionally be coated with chrome plate, thin dense chrome, tungsten carbide, chrome carbide, aluminum oxide, or other suitable material having a desired hardness. While particular materials for the inner ring member 64 and outer ring member 66 are disclosed, the invention is not limited in this regard, and in other embodiments any other suitable material may be used.

The liner 68 and the liner 64c both have a low coefficient of friction on the sliding surfaces and are referred to herein as self-lubricating liners. A bearing having a self-lubricating liner is referred to herein as a lined bearing or a self-lubricating bearing. In one embodiment, a self-lubricating liner comprises a fabric in which PTFE (polytetrafluoroethylene) fibers are interwoven with bondable glass, graphite, polyester, or other aramid fibers such that the PTFE fibers are at least partially exposed on one side of the fabric and the bondable glass, graphite, polyester, or aramid fibers are at least partially exposed on the other side of the fabric. The fabric structure is flooded with resin, which holds the fibers in place. The fabric is then bonded to the metal substrate, e.g., to the inner ring member 64, with an adhesive resin. This type of self-lubricating liner 68 is referred to as a flooded liner, since the working surface of the fabric is flooded with binding resin. The flooded liner provides a locking of the PTFE fibers for strength and resistance to cold flow, bearing surfaces which are almost entirely PTFE, and a surface which is bonded to the metal substrate of the bearing, e.g., to the convex surface 66a. While a self-lubricating liner comprising glass/graphite/polyester/aramid fibers/PTFE has been described, the invention is not limited in this regard, and in other embodiments other suitable liners may be used for lubricating effect, without departing from the broader aspects of the present invention. For example, in another embodiment, the self-lubricating liner 68 may molded and comprised of PTFE, glass, graphite, polyester, or aramid fibers in a thermosetting composite resin made from polyester, urethane, polyimide, epoxy, phenolic, or other type of resin.

Alternatively, the bearing linkage 20 may comprise bushings, such as the bushings 80, 82 as shown in FIG. 2E, as may any one or more of bearing linkages 34, 36, 20, 24a, and 24b. The bushing 80 includes a sleeve 80a, which has a cylindrical configuration, and a flange 80b at one end of the sleeve, but the invention is not limited in this regard, and in other embodiments, a bushing which does not include a flange may be used. The sleeve 80a is substantially tubular and has a central axis C with an interior surface that faces inward towards the central axis C. The flange 80b extends from one end of the sleeve 80a at substantially right angles to the central axis C. An outward surface of the flange 80b faces away from the sleeve 80a, and an inward surface of the flange faces toward the sleeve. As shown in FIG. 2E, the sleeve 80a and flange 80b serve as a substrate for the liners 84 that are disposed on the inside and outside surfaces of the sleeve 80a and also for the inward and outward surfaces of the flange 80b. However, the invention is not limited in this regard, and in other embodiments, there may be no liner (e.g., for a grease-lubricated-style bearing), or a liner may be disposed on any one or more of the inside and the outside of the sleeve 80a and the inward and outward surfaces of the flange 80b. The substrate material may be steel such as 17-4PH®, 15-5PH®, and PH13-8Mo®, AISI Type 300 or AISI Type 400 series stainless steel, aluminum, titanium, or bronze material. The liners 84 may be made from the same materials as the liner 68. The bushing 82 may have a similar structure and composition as the bushing 80. The linking pin 58 is held in place in the bushings 80, 82 by screws 70, 72 and washers 74, 76. The bushings 80, 82 are separated by a self-lubricating spacer 78.

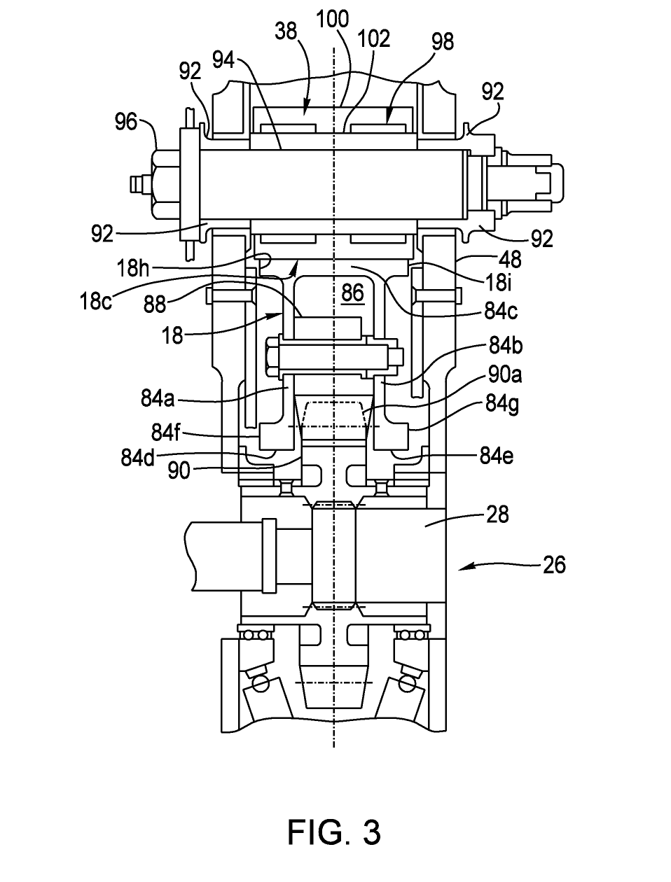

In one embodiment illustrated in FIG. 3, the track 18 has a Pi-beam configuration, i.e., having leg portions 84a, 84b connected by a cross-bar 84c and having an interior portion 86 to accommodate a gear track 88 therein. In this embodiment, the actuation system 26 includes a pinion gear 90 having teeth 90a positioned to drive the gear track 88. The cross bar 84c provides the side surfaces 18h, 18k and the top surface 18d opposite from the leg portions 84a, 84b. The leg portions 84a, 84b have bottom surfaces 84d, 84e for possible engagement with a track roller bearing, and mutually opposing side surfaces 84f, 84g for possible engagement with side roller bearings or side pads. The pinion gear 90 is coupled to the shaft 28 which rotates in response to flight control commands. As the shaft 28 and the pinion gear 90 rotate, a drive force is provided to the gear track 88 for driving the track 18 towards a retracted position or an extended position.

The track roller bearing 38 may be coupled to the mounting web 48 about the track 18. In one embodiment, the track roller bearing 38 is coupled to the mounting web 48 using opposing bushings 92, a mounting pin 94, and a nut 96. The opposing bushings 92 facilitate the mounting of the track rollers (e.g., either needle rollers 98 or self-lubricating rollers). The nut 96 may be a castellated nut to allow adjustment to the track 18 at fit-up. In one embodiment, the track roller bearing 38 includes a plurality of the needle rollers 98 (e.g., two rows of needle rollers in a double channel design) between an outer ring 100 and an inner ring 102. In one embodiment, the needle rollers 98, the outer ring 100, and/or the inner ring 102 are comprised of hardened stainless steel such as, for example, AISI Type 52100, AISI Type 440C, AISI Type 422 stainless steel treated with a nitriding process (AeroCres®) (AEROCRES is registered trademark of RBC Aircraft Products, Inc., Oxford, Conn. USA), XD-15NW, Cronidur 30®, or the like. The needle roller bearings may employ grease to lubricate the bearings. Such grease includes, for example, Aeroshell grease 33, Mobilgrease 28, Aerospec 200 grease, or Aeroplex 444 grease, but the invention is not limited in this regard, and any suitable grease may be used.

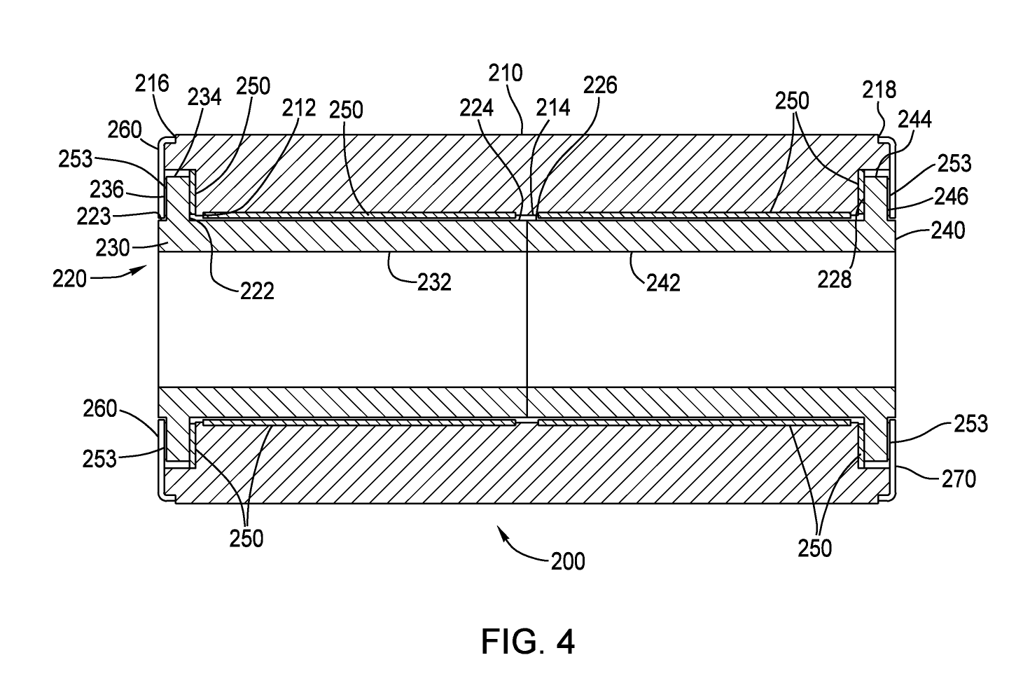

In another embodiment, a track roller bearing comprises a lined track roller bearing 200 which, as illustrated in FIG. 4, includes an outer ring 210 and an inner ring 220 defining a bore 221 through which the mounting pin 94 is received and secured by the nut 96. The inner ring 220 is a split ring including a first portion 230 and a second portion 240. In one embodiment, the first portion 230 and the second portion 240 include respective body portions 232 and 242 as well as head portions 234 and 244. The head portions 234 and 244 include flanges 236 and 246, respectively. The split ring configuration of the first portion 230 and the second portion 240, due to their ability to deflect relative to one another, accommodate potential deflection and/or bending of the mounting pin 94 in the bore 221 from stresses that may be encountered during, for example, aircraft takeoff and landing. The flanges 236 and 246 control axial motion of the outer ring 210 to substantially eliminate contact of the outer ring 210 and the opposing bushings 92 utilized to mount the track roller bearing 38 and lined track roller assembly 200 within the mounting web 48.

As shown in FIG. 4, the lined track roller bearing 200 may also include one or more liners 250 disposed between bearing surfaces 212, 214 of the outer ring 210 and bearing surfaces 222, 224, 226, and 228 of the inner ring 220. The liner 250 is a self-lubricating surface that is separated into sections to provide lubrication between the surfaces of the flanges 236, 246 and the body portions 232, 242. By separating the liner 250 into sections, deflection of the track roller (e.g., needle rollers 98 or other rollers) can be accommodated. Also, separation of the liner 250 can also prevent the binding of the track roller due to deflection of mounting shafts and other structure. The liner 250 may be the same as the self-lubricating liners 68 or 64c. In one embodiment, a liner 250 is constructed of PTFE (e.g., such as PTFE commercially available under the designation TEFLON®) (TEFLON is a registered trademark of E.I. DuPont De Nemours and Company, Wilmington, Del. USA), polyester, aramid, glass, graphite, fabric of fibers of any of the foregoing materials impregnated with a resin which may be a polyester, urethane, polyimide, epoxy, phenolic, or other type of resin. In one embodiment, the liner 250 is molded and is comprised of PTFE, polyester, graphite, fibers in a thermosetting composite resin made from polyester, urethane, polyimide, epoxy, phenolic, or other type of resin.

Optionally, the lined track roller bearing 200 may include seals 253 that are retained against the flanges 236 and/or the flange 246 by respective shields 260 and 270 disposed about shoulder portions 216 and 218 of an outer diameter of the outer ring 210 and extending to an outer diameter 223 of the inner ring 220. The seals 253 are fabricated from acetal, nylon, Delrin®, Celcon® with or without lubricant fillers such as PTFE, polyester, ultra high molecular weight polyethelene (UHMWPE), or other thermoplastic material. The shields 260, 270 may be constructed of various steels, for example, 301, 302, 304, 316, 17-4PH, 17-7PH, 15-5PH, or PH13-8Mo corrosion resistant steels. The shields 260 and 270 reduce friction and inhibit dust and other contaminates from entering and compromising contact between the bearing surfaces 212, 214 of the outer ring 210 and bearing surfaces 222, 224, 226, and 228 of the inner ring 220.

As shown in FIG. 5A, a plurality of side guide roller bearings 300 are disposed about opposing sides of the track 18. The side guide roller bearings 300 are in rotational contact with the opposing side surfaces 84f, 84g to guide the track 18, along with track roller bearings 38 and 200, in the arcuate path along axis A during deployment and retraction.

As shown in FIG. 5B, one side guide roller bearing 300 is shown. The side guide roller bearing 300 is a needle roller bearing having an outer race 310, an inner race 312 located on an outer surface of a pin 315, and needle rollers 316 located between the outer race and the inner race. The outer race 310 can include a crowned radius 317 to allow the needle rollers 316 to misalign slightly relative to the track 18 to accommodate deflection of the various components of the side guide roller bearing 300. The needle rollers 316 are constructed of hardened stainless steel such as, for example, AISI Type 52100, AISI Type 440C, AISI Type 422 stainless steel treated with a nitriding process (e.g., the aforementioned AeroCres® process), XD-15NW, or Cronidur 30. The side guide roller bearings 300 also include side washers 318 and one or more seals 320 located at the ends of the needle rollers 316. The side washers 318 are configured to accommodate axial and/or side loading of the needle rollers 316 and are constructed of, for example, AISI Type 52100 steel with cadmium plate or AISI Type 420 stainless steel. The seals 320 may be made from a thermoplastic polymer such as, for example, an acetal copolymer or Delrin®/Celcon® (DELRIN is a registered trademark of E.I. DuPont De Nemours and Company, Wilmington, Del. USA, and CELRON is a registered trademark of CNA Holdings, Inc., Summit, N.J. USA) with or without lubricant fillers such as PTFE or polyester. The seals 320 retain grease and prevent of ingress dirt, dust, and other contaminates into the bearings 300. In one embodiment, the needle rollers 316 are lubricated with grease such as, for example, Aeroshell 33, Mobil 28, Aerospec 200, or Aeroplex 444.

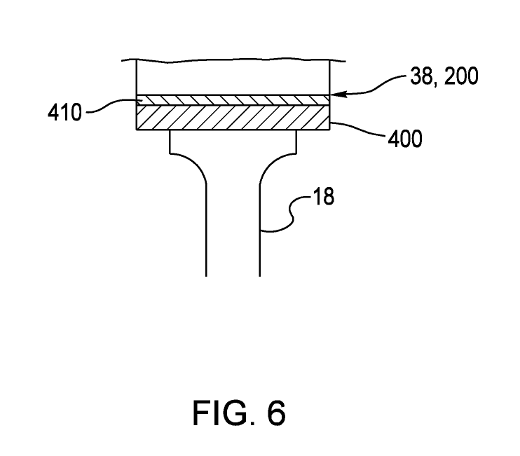

As shown in FIG. 6, the track roller bearing 38 and/or the lined track roller bearing 200 may include a hard outer ring 400 that engages the mating track 18 during operation. The hard outer ring 400 is typically fabricated from precipitation-hardening stainless steel such as, for example, custom 455 steel, having a Rockwell hardness in the range of about HRc 40 s. AISI Type 440C steel has also been used for outer rings. The hard outer ring 400 may also be manufactured from hardened high strength steel having a Rockwell hardness of about HRc 50 s. A typical Rockwell hardness is about 40 to 62 and is a function of the material selected for the outer race. Having a hard outer ring 400 that engages the mating track 18 during operation minimizes the opportunity for flat spots to occur on the surfaces of the outer race of the bearing.

In certain applications, it is also desirable to employ inner rings 410 manufactured from 17-4PH steel, and it is further desirable to employ outer rings 400 of AISI Type 422 stainless steel. In one embodiment, each of the outer rings 400 of the track roller bearings is comprised of AISI Type 422 stainless steel that has been subjected to a nitriding hardening process (e.g., the aforementioned AeroCres® process). Outer rings 400 comprised of AISI Type 422 stainless steel with nitriding hardening are preferred for superior corrosion resistance and performance as compared to outer rings manufactured of 440C steel.

In any of the foregoing embodiments, the drive mechanism and structural joints for the leading edge slats contain bushings and spherical bearings to accommodate mounting, rotation, and misalignments in the drive mechanism and structural joints.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. An aircraft wing comprising:
a wing structure;
a slat panel mounted on a track;
an actuator mechanism on the wing structure, the actuator mechanism being coupled to the track for moving the slat panel between a deployed position and a retracted position;
a plurality of track roller bearings on the wing structure, the track roller bearings rotatably contacting the track; and
a plurality of side roller bearings rotatably contacting at least one side of the track.

2. The aircraft wing of claim 1, wherein the actuator mechanism includes a shaft rotatably mounted on the wing structure;
an actuator arm coupled to the track; and
an actuator lever coupled to the shaft and to the actuator arm.

3. The aircraft wing of claim 1, wherein the actuator mechanism includes a shaft rotatably mounted on the wing structure;
a gear track coupled to the track; and
a pinion gear coupled to the shaft, the pinion gear having gear teeth that engage the gear track.

4. The aircraft wing of claim 1, wherein the track has a top surface and a bottom surface, and wherein the plurality of track roller bearings includes at least one track roller bearing in rotational contact with the top surface of the track and at least one track roller bearing in rotational contact with the bottom surface of the track.

5. The aircraft wing of claim 1, wherein the wing structure includes a mounting web enclosing at least a portion of the track and wherein the plurality of track roller bearings are coupled to the mounting web.

6. The aircraft wing of claim 1, wherein the track roller bearings are coupled to the mounting web with opposing bushings, a mounting pin, and a nut.

7. The aircraft wing of claim 6, wherein the opposing bushings allow adjustment to the track at fit-up.

8. The aircraft wing of claim 1, wherein the plurality of track roller bearings includes at least one track roller bearing having at least one of needle rollers and self-lubricating rollers.

9. The aircraft wing of claim 1, wherein the plurality of track roller bearings includes at least one lined track roller bearing which comprises:
an outer ring;
an inner ring within the outer ring; and
a liner between the inner ring and the outer ring;
wherein the inner ring is configured for accommodating deflection and bending of a mounting pin coupling the lined track roller bearing to the track.

10. The aircraft wing of claim 9, including a plurality of liners disposed between the inner bearing surfaces of the outer ring and the outer bearing surfaces of the inner ring.

11. The aircraft wing of claim 10, including a liner comprising at least one of polytetrafluoroethylene, polyester, graphite, fabric impregnated with a polymer, urethane, polyimide, epoxy, and a phenol resin.

12. The aircraft wing of claim 10, including a molded liner comprising at least one of polytetrafluoroethylene, glass, graphite, polyester, or aramid fibers in a thermosetting composite resin made from polyester, urethane, polyimide, epoxy, or a phenolic resin.

13. The aircraft wing of claim 10, wherein the outer ring has a shoulder portion and wherein the bearing includes a shield disposed about the shoulder portion of the outer ring and extending to an outer diameter of the inner ring.

14. The aircraft wing of claim 9, wherein inner ring includes a body portion and a head portion, and wherein the head portion has a flange for limiting axial motion of the outer ring.

15. The aircraft wing of claim 1, including a track roller bearing having an outer ring, an inner ring and needle rollers made from one or more steels selected from the group consisting of AISI Type 52100, AISI Type 440C, AISI Type 422 treated with a nitriding process, XD-15NW1, and Cronidur 30.

16. The aircraft wing of claim 1, including a track roller bearing having an inner ring manufactured from 17-4PH steel and an outer ring manufactured from of AISI Type 422 stainless steel.

17. The aircraft wing of claim 1, including a track roller bearing having an inner ring manufactured from 17-4PH steel and an outer ring manufactured from of AISI Type 422 stainless steel which is treated with a nitriding hardening process.

18. An aircraft wing comprising:
a wing structure;
a slat panel mounted on a track;
an actuator mechanism on the wing structure, the actuator mechanism being coupled to the track for moving the slat panel between a deployed position and a retracted position, the actuator mechanism including a shaft rotatably mounted on the wing structure, an actuator arm coupled to the track by a bearing linkage, and an actuator lever coupled to the shaft by a bearing linkage and to the actuator arm by a bearing linkage;
a plurality of track roller bearings on the wing structure, the track roller bearings rotatably contacting the track; and
a plurality of side roller bearings rotatably contacting at least one side of the track, wherein at least one bearing linkage comprises a spherical plain bearing.

19. The aircraft wing of claim 18, wherein at least one bearing linkage comprises a spherical plain bearing which includes an inner ring member and an outer ring member, and wherein the outer ring member is fabricated from a metal selected from the group consisting of 17-4PH, 15-5PH, PH13-8Mo, AISI Type 300 or 400 series stainless steel, and titanium, and wherein the inner ring member is fabricated from a metal selected from the group consisting of AISI Type 440C, AISI Type 52100, Custom 455®, Custom 465®, AISI Type 422 stainless surface-treated with a nitriding process, XD-15NW steel, Cronidur 30®, 17-4PH, 15-5PH, PH13-8Mo, and titanium.

20. The aircraft wing of claim 19, wherein the inner ring member is coated with chrome plating, thin dense chrome, or tungsten carbide.

21. The aircraft wing of claim 18, wherein at least one bearing linkage comprises a self-lubricated spherical plain bearing.

22. The aircraft wing of claim 18, wherein at least one bearing linkage comprises a bushing.

23. The aircraft wing of claim 18, wherein at least one bearing linkage comprises a self-lubricated bushing.

24. The aircraft wing of claim 18, wherein each of the plurality of track roller bearings comprises:
an outer ring;
an inner ring within the outer ring; and
a liner disposed between the inner split ring and the outer ring;
wherein the inner ring is comprised of 17-4PH steel and the outer ring comprises AISI Type 422 stainless steel with a nitriding hardening process.

25. An actuation system for deploying and retracting a lift assisting device of a wing of an aircraft, the actuation system comprising:
a track pivotally coupled to a lift assisting device;
an actuator coupled to the track; and
a plurality of track roller bearings rotatably contacting the track to guide the track along an arcuate path, the track roller bearing comprising,
an outer ring having inner bearing surfaces,
an inner ring having outer bearing surfaces,
a shield disposed about shoulder portions of an outer diameter of the outer ring and extending to an outer diameter of the inner ring, and
a seal located under the shield and retained against an outward facing surface of the inner ring.

26. The actuation system of claim 25, further comprising a plurality of side roller bearings rotatably contacting at least one side of the track to guide the track along the arcuate path.

27. The actuation system of claim 26, wherein the side roller bearing comprises,
an outer ring having inner bearing surfaces,
an inner ring having outer bearing surfaces,
a bearing element located between the inner ring and the outer ring,
a washer disposed about shoulder portions of an outer diameter of the inner ring and extending to an inner diameter of the outer ring,
at first seal located under the washer and retained against an outward facing surface of the outer ring, and
a second seal located adjacent the washer and retained against a surface of the inner ring.

28. The actuation system of claim 25, wherein the actuator comprises,
a shaft rotatably mounted in the wing,
a lever mounted on the shaft, and
an arm coupling the lever to the track.

29. The actuation system of claim 28, wherein the arm is pivotally coupled to the lever using a first bearing linkage, and wherein the arm is pivotally coupled to the track using a second bearing linkage.

30. The actuation system of claim 25, wherein the track roller bearing comprises at least one of a needle roller and a self-lubricating roller.

31. The actuation system of claim 25, wherein the track roller bearing further comprises at least one ring on an outer surface of the outer ring.
